(19) United States
(12) Patent Application Publication
(10) Pub. No.: US 2016/0257359 A1
(43) Pub. Date: Sep. 8, 2016

(54) PARKING A VEHICLE WITH THE USE OF AN ADDITIONAL TRACTION SYSTEM

(71) Applicant: DECYLION SP. Z O.O., Warszawa (PL)

(72) Inventor: MARCIN GROCHOWINA, RZESZÓW (PL)

(73) Assignee: DECYLION Sp. z o.o., WARSZAWA (PL)

(21) Appl. No.: 14/433,805

(22) PCT Filed: Mar. 20, 2014
(86) PCT No.: PCT/PL2014/000025

§ 371 Date: Apr. 6, 2015

(30) Foreign Application Priority Data
Mar. 10, 2014 (PL) P.407455

(51) Int. Cl. B62D 61/12; B62D 6/00

(52) U.S. Cl. CPC B62D 61/12; B62D 6/001

(57) ABSTRACT

Parking a vehicle with the use of an additional traction system allowing to move the vehicle at a low speed without starting its combustion engine characterised in that the vehicle is equipped with an additional traction system having an autonomous drive system controlled electronically by means of an intelligent controller (10) that allows to park the vehicle sideways with the use of a system of extendable and retractable additional wheels (5) mounted under chassis (6) of the vehicle by moving the vehicle in direction perpendicular to its normal driving direction.

The subject of the invention is parking a vehicle, especially a motor car or a truck, with the use of an additional traction system in situations when the available parking space is significantly limited.

Polish patent application No. P 352587 reveals a method and electronic circuit for measuring the distance to an obstacle especially when reversing a car in which for the purpose of the distance measurement, a common measurement circuit is used that at a predetermined moment of time is connected to the active sensor via a signal concentrator and a signal distributor both controlled by a programmed microprocessor that additionally generates electric pulses, detects the return echo, and converts the signal delay time into distance to the obstacle. The circuit comprises a microprocessor controlling an indicator to the output of which an amplifier is connected with the signal distributor, and subsequent outputs are connected with transmission-reception sensors, connected at the same time to respective inputs of the signal concentrator output of which is connected with the microprocessor via a selective receiving amplifier.

European patent description No. EP 0 529 252 reveals a bearing assembly for trailer axle wheel in which the fixing nut located near the wheel axle journal end is provided with a plurality of radial slits. The angular pitch determining position of slits provided on the nut perimeter is uneven and corresponds to, in the clockwise direction, twice 60°, once 45°, twice 60°, and once 75°. Thanks to such pitch, the maximum angle of rotation of the nut that allows to tuck a locking bolt into the slit is 15°. Such angle value ensures good and in most cases sufficient axial mounting of the bearing assembly by means of a nut.

Equally important, and probably even more important for optimum mounting of the bearing assembly is the force with which the centre nut puts pressure on inner ring of the outer bearing as this is a factor affecting, among other things, the resistance posed by a rotating wheel and the service life of the bearing assembly. For this reason, wheel bearing assembly design solutions include typically the maximum allowable torque value for tightening the centre nut. However, obtaining the correct maximum tightening torque depends on proper adjustment and maintenance of the tension spanner used to tightening the centre nut.

From German patent description No. DE 37 13 224 known is a central nut secured by means of a locknut and provided, on its front surface oriented towards the bearings, with a abradable layer by means of which, after being tightened with a predetermined torque, the central nut stops against the inner ring of the outer bearing. The employed abradable layer is made of a material that is permanently resistant to axial pressure resulting from tightening the nut which however vanishes in the course of operation of the vehicle with increasing temperature of the beating assembly thus resulting in occurrence of a desired slackness in the bearing assembly. In order to avoid any undesired increase of the bearing slackness and protect the nut against loosening in further operation, the nut is secured with a locknut.

The objective of the present invention is to provide an additional traction system with autonomous drive and electronic control exercised by means of an intelligent controller allowing to park a vehicle sideways in a space longer than the vehicle's length by only a dozen or so centimetres.

The essential idea of the invention consists in that the vehicle is equipped with an additional traction system provided with an autonomous drive and controlled electronically by means of an intelligent controller that allows to park sideways thanks to a system of additional wheels mounted under the vehicle's chassis together with a system for extending and retracting said wheels, said traction system thus allowing to move the vehicle in direction perpendicular to its normal driving direction.

The autonomous drive system is powered with electric current supplied from the vehicle's electrical system and allows to move the vehicle at a low speed without starting its combustion engine. In the course of normal driving cycle, the additional wheels are hidden under the chassis and have no impact at all on traction properties of the vehicle. After locking the additional wheel system in the extended position, the vehicle is slightly lifted so that the wheels on which the vehicle is normally driven lose contact with the road surface which allows to move the vehicle sideways and, as a result, park it in a very limited parking space of the “envelope” type.

The additional traction system comprises four modules mounted to control arms of the vehicle suspension and an electronic control device. Each of the modules comprises an actuator used to extend or retract the respective module, a wheel driven by an independent electric motor and equipped with a velocity and position measurement and stabilisation system. The controller circuit controls the rotational speed of wheels thus providing control of position and motion of the vehicle. In view of different control arm designs employed in different vehicle models it is necessary to adapt the module to the actual vehicle suspension by determining arrangement and lengths of the module components and identifying the points of attachment and the method by means of which two brackets for mounting the module structure and the actuator moving the module will be attached to the vehicle's control arms.

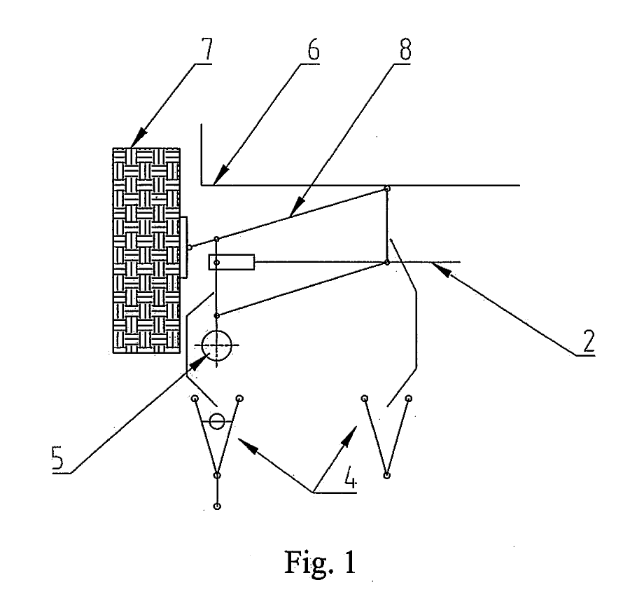

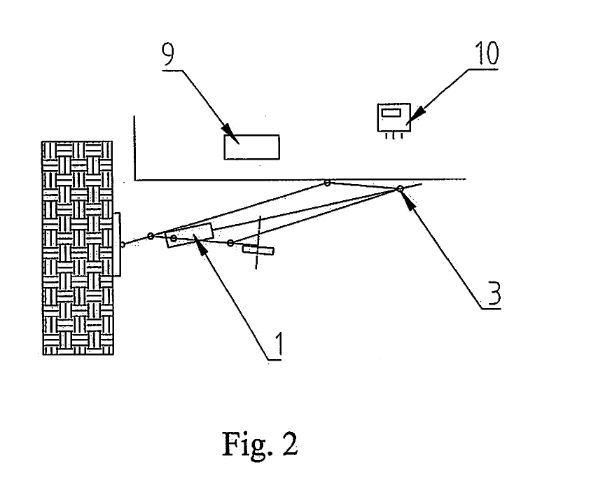

The subject of the present invention is explained in more detail by means of an example embodiment shown in schematic drawings, of which FIG. 1 represents a motor car supported by the mechanism revealed in this description with said mechanism being lowered, whereas FIG. 2 represents a motor car in which the mechanism is folded (hidden) under the chassis.

The additional traction system is equipped with controller 10 and comprises four brackets with modules 9 mounted to control arms 8. On the bracket, actuator 1 is also mounted for extending the structure by rotating a threaded road 2 that moves a threaded bushing 3 mounted at articulated joints 4 and thus resulting in lowering the small wheels 5. Owing to the fact that in the course of folding the mechanism, the small wheels 5 rotate by 90 degrees, their position after folding is almost horizontal and thus any significant reduction of the clearance under the vehicle chassis 6 is avoided when the vehicle's driving wheels 7 rest on the road surface.

In view of different control arm design solutions applied in automobiles of different brands it is necessary to adapt the additional traction system by means of determining arrangement and length of its individual components as well as defining attachment points at which said components will be mounted to control arms of the vehicle together with an appropriate mounting method.

1. Parking a vehicle with the use of an additional traction system allowing the vehicle to be driven at al low speed without starting the combustion engine characterised in that the vehicle is equipped with an additional traction system with autonomous drive
controlled electronically by means of an intelligent controller (10) that allows to park the vehicle sideways with the use of a system of additional wheels (5) mounted under chassis (6) of the vehicle together with a system for extending and retracting said additional wheels thus allowing to move the vehicle in direction perpendicular to its normal driving direction.

2. Parking a vehicle according to claim 1 characterised in that a bracket with module (9) is mounted to the control arm (8) of the vehicle together with an actuator (1) rotating a threaded bar (2) which moves a threaded sleeve (3) mounted on articulated joints (4) of small wheels (5) of the system.

3. Parking a vehicle according to claim 1 characterised in that when the vehicle is lowered and positioned on its wheels (7), small wheels (5) rotate by 90 degrees while the system is retracted.
